(19) United States
(12) Patent Application Publication
(10) Pub. No.: US 2016/0047941 A1
(43) Pub. Date: Feb. 18, 2016

(54) GAMMA RAY MEASUREMENT QUALITY CONTROL

(71) Applicant: SCHLUMBERGER TECHNOLOGY CORPORATION, Sugar Land, TX (US)

(72) Inventors: Marie-Laure Mauborgne, Fontenay Aux Roses (FR); Francoise Allioli, Paris (FR)

(21) Appl. No.: 14/781,351

(22) PCT Filed: Mar. 25, 2014
(86) PCT No.: PCT/US14/31719

§ 371 Date: Sep. 30, 2015

Related U.S. Application Data
(60) Provisional application No. 61/806,875, filed on Mar. 30, 2013.

(30) Foreign Application Priority Data
Mar. 30, 2013 (EP) 13305422.1

(51) Int. Cl. G01V 13/00; G01V 5/04

(52) U.S. Cl. CPC G01V 13/00; G01V 5/045

(57) ABSTRACT

Methods and apparatus for obtaining neutron population data of a subterranean formation with a downhole tool proximate the subterranean formation in a wellbore extending from a wellsite surface to the formation, wherein surface equipment is located at the wellsite surface. At least one of the downhole tool and the surface equipment is operated to generate a sigma log, determine moment data from the generated sigma log, determine a real quality control factor based on the determined moment data, and determine a theoretical quality control factor based on the generated sigma log. Comparing the determined real and theoretical quality control factors may then be utilized to assess accuracy of the generated sigma log.

### BACKGROUND OF THE DISCLOSURE

Determining the characteristics of a subterranean formation to obtain hydrocarbon content information may utilize a downhole tool having a source operable to irradiate the formation. Sensors in the tool may detect the radiation intensity or decay rate resulting from the manner in which the formation constituents have interacted with the source radiation. One such logging tool includes a pulsed accelerator neutron source, whereby high-energy neutrons penetrate and interact with the formation, and the energy of the neutrons is decreased. Upon the resulting capture of neutrons in the nuclei of the formation constituents, the energized nuclei release a gamma ray, and the amplitude and decay time characteristics of the gamma rays detected by the tool represent the volume-averaged characteristics of the constituents of the borehole and the surrounding formation. Formation characteristics of interest to users of such logging tools include the macroscopic thermal capture cross-section of the formation (formation sigma, or sigma, in capture units, c.u.) and formation porosity (in porosity units, p.u.).

### SUMMARY OF THE DISCLOSURE

The present disclosure introduces one or more methods in which a downhole tool is operated to obtain neutron population data of a subterranean formation, wherein the downhole tool is positioned proximate the subterranean formation in a wellbore extending from a wellsite surface to the formation, and wherein surface equipment is located at the wellsite surface. At least one of the downhole tool and the surface equipment is operated to generate a sigma log, determine moment data from the generated sigma log, determine a real quality control factor based on the determined moment data, and determine a theoretical quality control factor based on the generated sigma log. Accuracy of the generated sigma log may then be assessed by comparing the determined real and theoretical quality control factors.

The present disclosure also introduces one or more methods in which a downhole tool is operated to obtain neutron population data of a subterranean formation, wherein the downhole tool is positioned proximate the subterranean formation in a wellbore extending from a wellsite surface to the formation, and wherein surface equipment is located at the wellsite surface. At least one of the downhole tool and the surface equipment is operated to generate a sigma log, determine moment data from the generated sigma log, determine a real quality control factor based on the determined moment data, and determine a theoretical quality control factor based on the generated sigma log. Accuracy of the generated sigma log may then be assessed by comparing the determined real and theoretical quality control factors. A correction for a sensor standoff associated with operation of the downhole tool may then be made based on the comparison of the determined real and theoretical quality control factors.

The present disclosure also introduces a downhole tool operable to obtain neutron population data of a subterranean formation when the downhole tool is positioned proximate the subterranean formation in a wellbore extending from a wellsite surface to the formation. The downhole tool is associated with surface equipment located at the wellsite surface. The downhole tool and the surface equipment are collectively operable to generate a sigma log, determine moment data from the generated sigma log, determine a real quality control factor based on the determined moment data, and determine a theoretical quality control factor based on the generated sigma log. Accuracy of the generated sigma log may be assessed by comparing the determined real and theoretical quality control factors.

Additional aspects of the present disclosure are set forth in the description that follows, and/or may be learned by a person having ordinary skill in the art by reading the materials herein and/or practicing the principles described herein. At least some aspects of the present disclosure may be achieved via means recited in the attached claims.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a graph depicting one or more aspects of the present disclosure.

FIG. 2 is a graph depicting one or more aspects of the present disclosure.

FIG. 3 is a graph depicting one or more aspects of the present disclosure.

FIG. 4 is a graph depicting one or more aspects of the present disclosure.

FIG. 5 is a graph depicting one or more aspects of the present disclosure.

FIG. 6 is a schematic view of at least a portion of apparatus according to one or more aspects of the present disclosure.

FIG. 7 is a schematic view of at least a portion of apparatus according to one or more aspects of the present disclosure.

FIG. 8 is a schematic view of at least a portion of apparatus according to one or more aspects of the present disclosure.

FIG. 9 is a flow-chart diagram of at least a portion of a method according to one or more aspects of the present disclosure

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The macroscopic thermal neutron population cross-section data of a formation surrounding a wellbore may be measured by determining the rate of decay of the thermal neutron signal or the rate of decay of the gamma ray signal with a downhole logging tool. The decay of the neutron population after a burst of neutrons has been thermalized may be approximated by an exponential relationship. Obtaining the decay constant may comprise determining low order moments of the quasi-exponential time decay spectrum. An invariant value may be found by combining different moments of an exponential relationship. If the decay function is close to or approximates an exponential relationship, the deviation from the invariant value may be utilized to determine how closely the relationship mimics an exponential relationship.

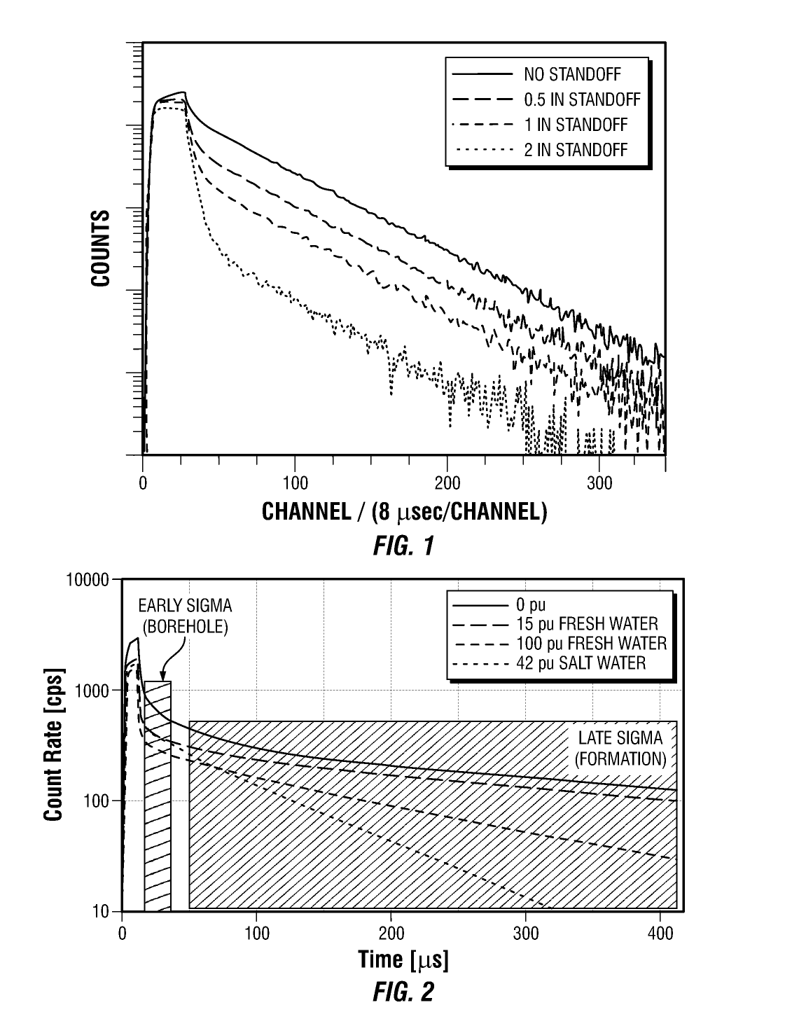

In the case of the thermal neutron decay or die-away, the relationship may deviate from an exponential relationship due to one or more environmental factors, such as tool standoff, invasion, and background signals, among others. An example of such deviation attributable to tool standoff is depicted in FIG. 1. Measuring the deviation from the invariant value may provide quality control (QC), and may also be utilized for correction algorithms to account for the deviation from the standard case.

Sigma is the macroscopic thermal neutron population cross-section data of the formation. The measurement makes use of the fact that, after slowing down due to thermal energy, neutrons linger in the formation and the wellbore for several hundred microseconds, undergoing multiple collisions with nuclei in the surrounding material. Their capture by formation (and wellbore) nuclei results in the emission of one or more gamma rays from the resulting highly excited nucleus.

As the neutron population near the tool declines due to capture and drift of the neutrons further away from the tool (diffusion), the neutron and gamma ray count rates observed in detectors of the tool will decrease. Most of the decrease is attributable to the decline of the neutron population due to neutron capture. The measurement is therefore sensitive to the presence of thermal absorbers in the formation surrounding the tool. For example, chlorine has a much higher capture cross-section than most other elements generally found in well logging. Accordingly, sigma may be utilized as an indicator of the chlorine concentration around the tool and, thus, of the formation fluid salinity.

The sigma measurement may be obtained utilizing one or more gamma ray detectors of a downhole tool. Examples of such downhole tools include, without limitation, ECOSCOPE, HIGHLY INTEGRATED GAMMA NEUTRON SONDE (HGNS), HOSTILE ENVIRONMENT TELEMETRY AND GAMMA RAY CARTRIDGE (HTGC), SCINTILLATION GAMMA RAY TOOL (SGT), SLIM TELEMETRY AND GAMMA RAY CARTRIDGE (STGC), SLIMXTREME TELEMETRY AND GAMMA RAY CARTRIDGE (QTGC), and COMBINABLE GAMMA RAY SONDE (CGRS), each of SCHLUMBERGER. The gamma ray count rate may be determined as a function of time. An initial decrease in the count rate may be due to downhole effects of the tool and the wellbore proximate the detector. The wellbore effect may be relatively small for sigma logs acquired utilizing certain downhole tools where, like with ECOSCOPE, the larger logging while drilling (LWD) collar may displace a substantial portion of the mud in the wellbore. Example decay spectra are depicted in FIG. 2.

Assuming a single exponential decay, the decay rate of the gamma rays may be given by Equation (1), set forth below:

N(t)=N₀e^{-t/τ} (1)

where: N(t) is the count rate at time t;

N₀ is the initial count rate; and

τ is the decay constant of the quasi-exponential decay of the gamma rays in μs.

Sigma (Σ, in capture units, c.u.) may be related to the decay rate of the gamma ray counts in the detector by Equation (2), set forth below:

Σ=4550/τ (2)

Sigma (Σ) is a volumetric measurement related to the chlorine content of the formation. Because chlorine generally occurs dissolved in the formation water, sigma (Σ) may be utilized to determine resistivity-independent water saturation if, for example, the formation water salinity is known and the water is sufficiently saline to produce a usable sigma contrast between water and hydrocarbons. This may be utile where the traditional, resistivity-based methods of estimating water saturation fail to provide reliable results (such as in some low-resistivity pay zones), among other implementations. It may be a robust process and, as such, may be utilized with low count rates. However, it may be sensitive to the environment and/or the depth of investigation.

The process may be based on the determination of the first moment of the decay curve, as set forth below in Equation (3):

$$τ = \frac{{\sum }_{i = first}^{last} t ( i ) TCR ( i )}{{\sum }_{i = first}^{last} TCR ( i )} = \frac{{M}_{1}}{{M}_{0}} \qquad ( 3 )$$

where: t(i) is the time of moment i; and

TCR(i) is the total count rate at moment i.

At this point in the process, there are no QC considerations. However, moments of exponentials may be utilized to determine how close the decay is to being exponential. Assuming that M₀ is the first moment, M₁ is the second moment, and M₂ is the third moment, they may be expressed in terms of integrals (λ=1/τ), as set forth below in Equations (4), (5), and (6):

M₀=∫₀^{∞}exp(−λt)dt (4)

M₁=∫₀^{∞}exp(−λt)tdt (5)

M₂=∫₀^{∞}exp(−λt)t²dt (6)

M₁ and M₂ may then be rewritten using integration by parts, as set forth below in Equations (7), (8), (9), and (10):

$$\begin{matrix}{M}_{1} = {[ - \frac{1}{λ} exp ( - λ t ) t ]}_{0}^{∞} + \frac{1}{λ} {\int }_{0}^{∞} exp ( - λ t ) d t & ( 7 ) \\ {M}_{1} = \underbrace{{[ - \frac{1}{λ} exp ( - λ t ) t ]}_{0}^{∞}}_{= 0} + \frac{1}{λ} {M}_{0} & ( 8 ) \\ {M}_{2} = {[ - \frac{1}{λ} exp ( - λ t ) {t}^{2} ]}_{0}^{∞} + \frac{2}{λ} {\int }_{0}^{∞} exp ( - λ t ) t d t & ( 9 ) \\ {M}_{2} = \underbrace{{[ - \frac{1}{λ} exp ( - λ t ) {t}^{2} ]}_{0}^{∞}}_{= 0} + \frac{2}{λ} {M}_{1} & ( 10 )\end{matrix}$$

Accordingly, a relationship between the moments may be determined, as set forth below in Equation (11):

$$\frac{{M}_{0} {M}_{2}}{{M}_{1}^{2}} = 2 \qquad ( 11 )$$

If the decay is not purely exponential, however, the ratio value may be greater than or less than two (2).

To implement the aspects described above, the ratio QCr (measured, or “real”) may be determined by, for example, utilizing Equations (12), (13), (14), and (15) set forth below:

$$\begin{matrix}{M}_{0} = {\sum }_{i = first}^{last} TCR ( i ) & ( 12 ) \\ {M}_{1} = {\sum }_{i = first}^{last} ( t ( i ) \times TCR ( i ) ) & ( 13 ) \\ {M}_{2} = {\sum }_{i = first}^{last} ( {t ( i )}^{2} \times TCR ( i ) ) & ( 14 ) \\ QCr = \frac{{M}_{0} \times {M}_{2}}{{M}_{1}^{2}} & ( 15 )\end{matrix}$$

Moreover, the first, second, and third moments of the exponential decay function may be expressed as set forth below in Equations (16), (17), and (18):

M₀=(−4550×N(t))/(Σ×N₀) (16)

M₁=(4550×M₀)/Σ (17)

M₂=2(4550×M₁)/Σ (18)

where: M₀ is the first moment;

M₁ is the second moment;

M₂ is the third moment;

N(t) is the detected neutron or gamma ray count at time t; and

N₀ is the detected neutron or gamma ray count at time t=0.

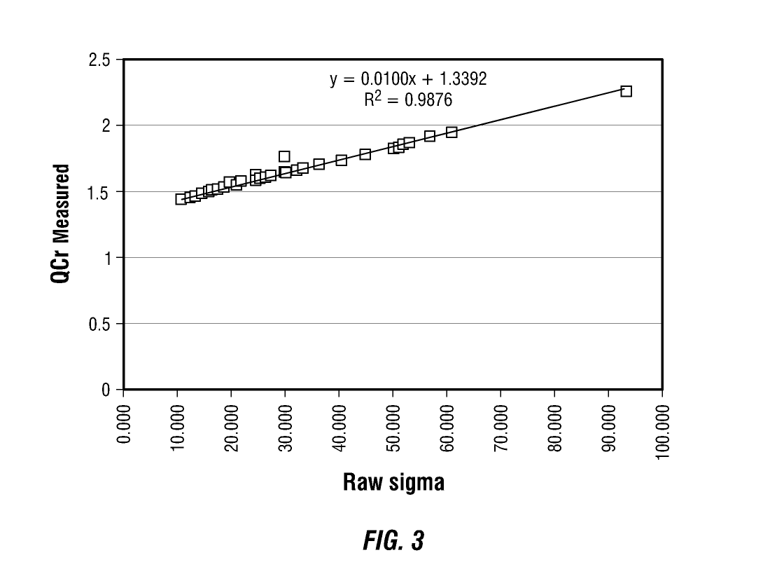

Implementation of the above with data obtained from a preexisting environmental effect calibration database may result in a ratio QCr that is lower than two (2), which may indicate a dependence on sigma, as depicted in FIG. 3. Also depicted in FIG. 3 are several points that are outside of the linear fit, which may correspond to the worst conditions in the database.

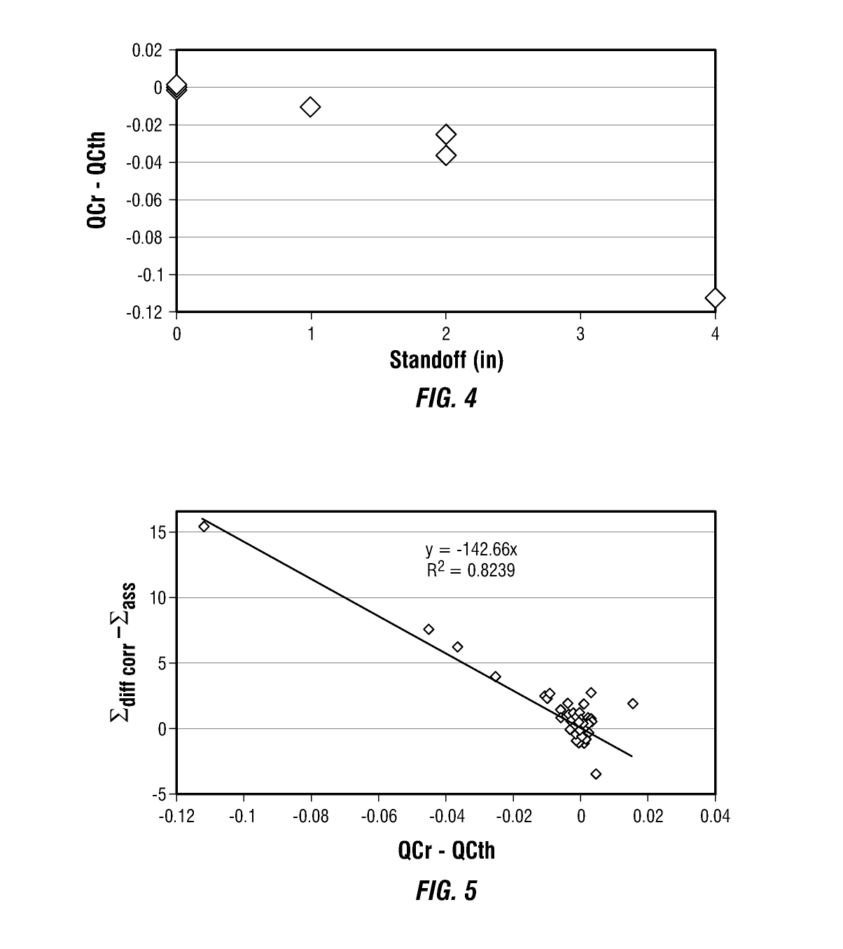

Nonetheless, there appears to be a linear dependence of QCr from the raw sigma. Accordingly, a theoretical response QCth may be obtained by, for example, fitting the dependence. The difference between the QCth and the QCr, as depicted in FIG. 4, may indicate issues regarding the shape of the decay. Among other things, this may be due to the lack of contact between the tool and the formation. The value of the difference may depend on the standoff and/or the contrast between the sigma of the mud and the formation. Therefore, the difference may be an indicator of the impact of standoff on the measurement.

If experimental data with obvious issues are removed (as may be determined by various criteria), the general shape of correction for sigma may be as set forth below in Equation (19):

Σ_{corr}=f(Σ_{raw})+g(Φ)+h(BS, BSal, . . . ) (19)

where: the functions f, g, and h are determined from the experimental database;

Σ_{raw} is the sigma before correction; and

Σ_{corr} is the corrected sigma.

Considering experimental data without wellbore corrections (i.e., excluding experimental data with wellbore corrections) may result in Equation (20) set forth below:

Σ_{diffcorr}=f(Σ_{raw})+g(Φ) (20)

Comparison to the assigned Σₐₛₛ values, looking at Σ_{diffcorr}−Σₐₛₛ as a function of QCr−QCth, may result in the linear relationship depicted in FIG. 5.

In FIG. 5, negative values of QCr−QCth may indicate a need for wellbore correction. From this, however, one can obtain a correction based solely on QCr−QCth, which is independent of the wellbore parameters often utilized for the wellbore correction of sigma, such as wellbore size, wellbore salinity, and others that may be entered by an operator. By utilizing the difference between the predicted and the measured QC values, one may determine whether additional correction is required.

One or more aspects of the above-described moments ratio method may provide an approach to QC that may indicate deviations of the decay function from an expected shape. For example, it may provide QC with respect to tool problems and/or uncorrected environmental effects or algorithm limitations in the subtraction of the background in the decay spectra that may not be associated with the die-away of the thermal neutrons. One or more aspects described above may also be utilized to refine the environmental corrections and/or allow an automatic correction for tool standoff. Example implementations of one or more such aspects are described below, although others are also within the scope of the present disclosure.

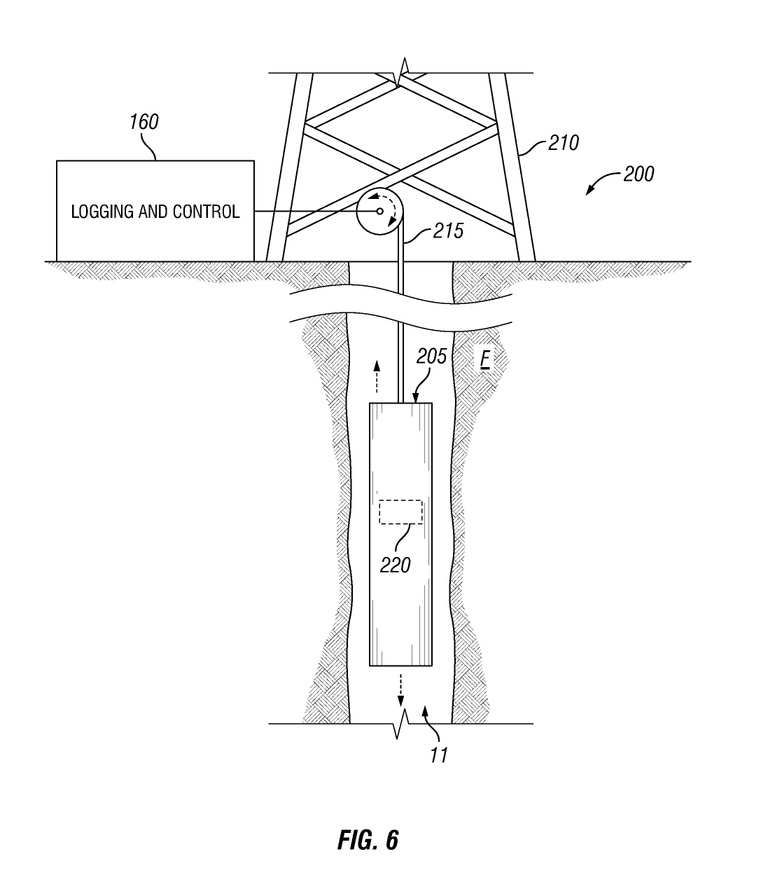

FIG. 6 is a schematic view of an example wellsite system that may be employed onshore and/or offshore according to one or more aspects of the present disclosure. As depicted in FIG. 6, a downhole tool 205 may be suspended from a rig 210 in a wellbore 11 formed in one or more subterranean formations F. The downhole tool 205 may be or comprise an acoustic tool, a conveyance tool, a density tool, a downhole fluid analysis (DFA) tool, an electromagnetic (EM) tool, a fishing tool, a formation evaluation tool, a gamma ray tool, a gravity tool, an intervention tool, a magnetic resonance tool, a monitoring tool, a neutron tool, a nuclear tool, a perforating tool, a photoelectric factor tool, a porosity tool, a reservoir characterization tool, a reservoir fluid sampling tool, a reservoir pressure tool, a reservoir solid sampling tool, a resistivity tool, a sand control tool, a seismic tool, a stimulation tool, a surveying tool, and/or a telemetry tool, although other downhole tools are also within the scope of the present disclosure. The downhole tool 205 may be deployed from the rig 210 into the wellbore 11 via a conveyance means 215, which may be or comprise a wireline cable, a slickline cable, and/or coiled tubing, although other means for conveying the downhole tool 205 within the wellbore 11 are also within the scope of the present disclosure. As the downhole tool 205 operates, outputs of various numbers and/or types of the downhole tool 205 and/or components thereof (one of which is designated by reference numeral 220) may be sent via, for example, telemetry to a logging and control system 160 at surface, and/or may be stored in various numbers and/or types of memory for subsequent recall and/or processing after the downhole tool 205 is retrieved at the surface. The downhole tool 200, the downhole tool 220, and/or the logging and control system 160 may be utilized to perform at least a portion of one or more methods according to one or more aspects of the present disclosure.

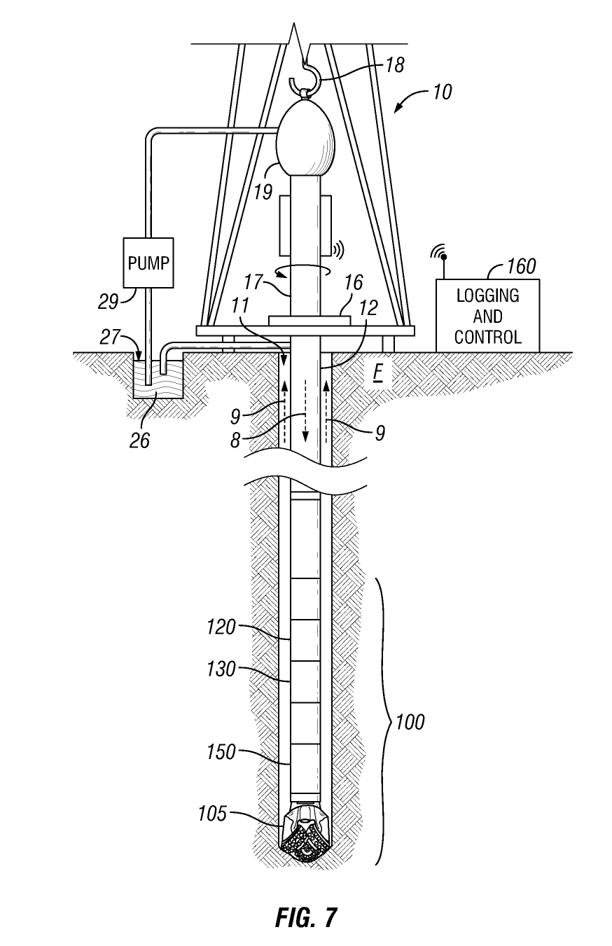

FIG. 7 is a schematic view of an example wellsite system that can be employed onshore and/or offshore, perhaps including at the same wellsite as depicted in FIG. 6, where the wellbore 11 may have been formed in the one or more subsurface formations F by rotary and/or directional drilling. As depicted in FIG. 7, a conveyance means 12 suspended within the wellbore 11 may comprise or be connected to a bottom hole assembly (BHA) 100, which may have a drill bit 105 at its lower end. The conveyance means 12 may comprise drill pipe, wired drill pipe (WDP), tough logging conditions (TLC) pipe, coiled tubing, and/or other means of conveying the BHA 100 within the wellbore 11.

The surface system at the wellsite may comprise a platform and derrick assembly 10 positioned over the wellbore 11, where such derrick may be substantially similar or identical to the rig 210 shown in FIG. 6. The assembly 10 may include a rotary table 16, a kelly 17, a hook 18, and/or a rotary swivel 19. The conveyance means 12 may be rotated by the rotary table 16, energized by means not shown, which may engage the kelly 17 at the upper end of the conveyance means 12. The conveyance means 12 may be suspended from the hook 18, which may be attached to a traveling block (not shown), and permits rotation of the drillstring 12 through the kelly 17 and the rotary swivel 19. A top drive system may also or instead be utilized.

The surface system may also include drilling fluid 26, which is commonly referred to in the industry as mud, stored in a pit 27 formed at the well site. A pump 29 may deliver the drilling fluid 26 to the interior of the conveyance means 12 via a port (not shown) in the swivel 19, causing the drilling fluid to flow downwardly through the conveyance means 12 as indicated by the directional arrow 8. The drilling fluid 26 may exit the conveyance means 12 via ports in the drill bit 105, and then circulate upwardly through the annulus region between the outside of the conveyance means 12 and the wall of the wellbore, as indicated by the directional arrows 9. The drilling fluid 26 may be used to lubricate the drill bit 105, carry formation cuttings up to the surface as it is returned to the pit 27 for recirculation, and/or create a mudcake layer (not shown) on the walls of the wellbore 11. Although not pictured, one or more other circulation implementations are also within the scope of the present disclosure, such as a reverse circulation implementation in which the drilling fluid 26 is pumped down the annulus region (i.e., opposite to the directional arrows 9) to return to the surface within the interior of the conveyance means 12 (i.e., opposite to the directional arrow 8).

The BHA 100 may include various numbers and/or types of downhole tools, schematically depicted in FIG. 7 as tools 120, 130, and 150. Examples of such downhole tools include an acoustic tool, a density tool, a directional drilling tool, a DFA tool, a drilling tool, an EM tool, a fishing tool, a formation evaluation tool, a gamma ray tool, a gravity tool, an intervention tool, a logging while drilling (LWD) tool, a magnetic resonance tool, a measurement while drilling (MWD) tool, a monitoring tool, a mud logging tool, a neutron tool, a nuclear tool, a perforating tool, a photoelectric factor tool, a porosity tool, a reservoir characterization tool, a reservoir fluid sampling tool, a reservoir pressure tool, a reservoir solid sampling tool, a resistivity tool, a seismic tool, a stimulation tool, a surveying tool, a telemetry tool, and/or a tough logging condition (TLC) tool, although other downhole tools are also within the scope of the present disclosure. One or more of the downhole tools 120, 130, and 150, and/or the logging and control system 160, may be utilized to perform at least a portion of one or more methods according to one or more aspects of the present disclosure.

The downhole tools 120, 130, and/or 150 may be housed in a special type of drill collar, as it is known in the art, and may include capabilities for measuring, processing, and/or storing information, as well as for communicating with the other downhole tools 120, 130, and/or 150, and/or directly with surface equipment, such as the logging and control system 160. Such communication may utilize various conventional and/or future-developed two-way telemetry systems, such as a mud-pulse telemetry system, a wired drill pipe telemetry system, an electromagnetic telemetry system, and/or an acoustic telemetry system, among others within the scope of the present disclosure. One or more of the downhole tools 120, 130, and/or 150 may also comprise an apparatus (not shown) for generating electrical power for use by the BHA 100. Example devices to generate electrical power include, but are not limited to, a battery system and a mud turbine generator powered by the flow of the drilling fluid.

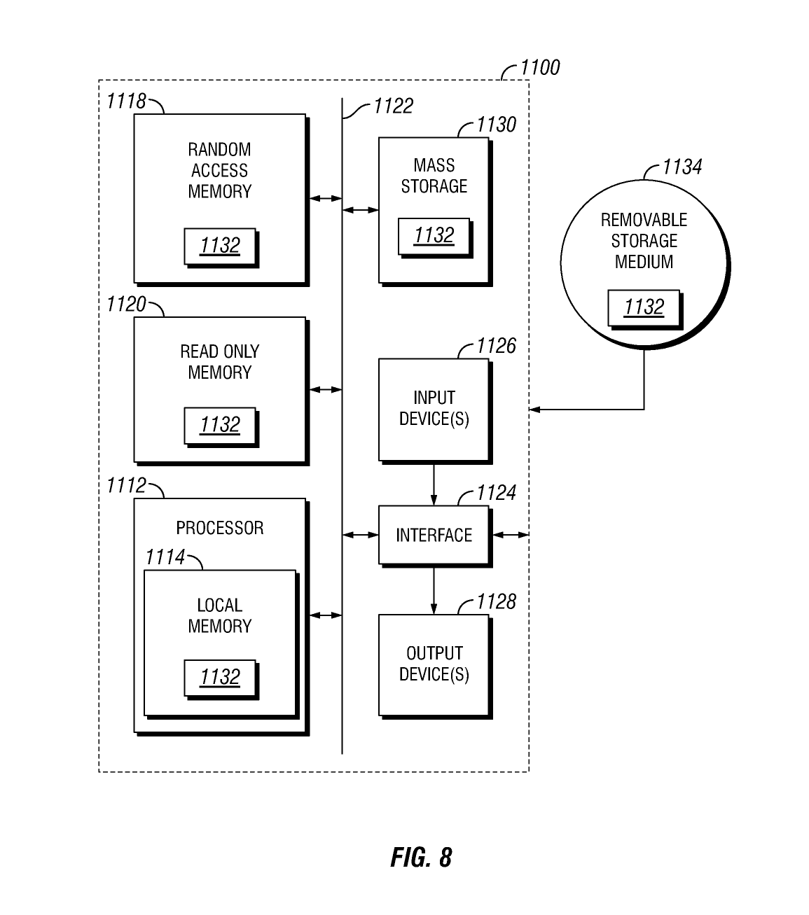

FIG. 8 is a block diagram of an example processing system 1100 that may execute example machine-readable instructions to implement one or more aspects of the methods and/or processes described herein, and/or to implement the example downhole tools described herein. The processing system 1100 may be at least partially implemented in one or more of the downhole tools 200 and 220 shown in FIG. 6, in one or more of the downhole tools 120, 130, and/or 150 shown in FIG. 7, in one or more surface equipment components (e.g., the logging and control system 160 shown in FIGS. 6 and/or 7, and/or one or more components thereof), and/or in some combination thereof. The processing system 1100 may be or comprise, for example, one or more processors, controllers, special-purpose computing devices, servers, personal computers, personal digital assistant (PDA) devices, smartphones, internet appliances, and/or various other types of computing devices.

The system 1100 comprises a processor 1112 such as, for example, a general-purpose programmable processor. The processor 1112 includes a local memory 1114, and executes coded instructions 1132 present in the local memory 1114 and/or in another memory device. The processor 1112 may execute, among other things, machine-readable instructions to implement the methods and/or processes described herein. The processor 1112 may be, comprise, or be implemented by various types of processing units, such as one or more INTEL microprocessors, microcontrollers from the ARM and/or PICO families of microcontrollers, and/or embedded soft/hard processors in one or more FPGAs, although other processors from other families are also appropriate.

The processor 1112 is in communication with a main memory including a volatile (e.g., random access) memory 1118 and a non-volatile (e.g., read-only) memory 1120 via a bus 1122. The volatile memory 1118 may be, comprise, or be implemented by static random access memory (SRAM), synchronous dynamic random access memory (SDRAM), dynamic random access memory (DRAM), Rambus dynamic random access memory (RDRAM), and/or various other types of random access memory devices. The non-volatile memory 1120 may be, comprise, or be implemented by flash memory and/or various other types of memory devices. One or more memory controllers (not shown) may control access to the main memory 1118 and/or 1120. One or both of the volatile memory 1118 and the non-volatile memory 1120 may include coded instructions 1132, as described above.

The processing system 1100 also includes an interface circuit 1124. The interface circuit 1124 may be, comprise, or be implemented by various types of standard interfaces, such as an Ethernet interface, a universal serial bus (USB), and/or a third generation input/output (3GIO) interface, among others.

One or more input devices 1126 are connected to the interface circuit 1124. The input devices 1126 permit a user to enter data and commands into the processor 1112. The input devices may be, comprise, or be implemented by, for example, a keyboard, mouse, touchscreen, track-pad, trackball, and/or a voice recognition system, among others.

One or more output devices 1128 are also connected to the interface circuit 1124. The output devices 1128 may be, comprise, or be implemented by, for example, display devices (e.g., a liquid crystal display (LCD) or cathode ray tube display (CRT), among others), printers, and/or speakers, among others. Thus, the interface circuit 1124 may also comprise a graphics driver card.

The interface circuit 1124 may also include a communication device (not shown) such as a modem or network interface card to facilitate exchange of data with external computers via a network (e.g., Ethernet connection, digital subscriber line (DSL), telephone line, coaxial cable, cellular telephone system, satellite, etc.).

The processing system 1100 also includes one or more mass storage devices 1130 for storing machine-readable instructions and/or data. Examples of such mass storage devices 1130 include floppy disk drives, hard drive disks, compact disc (CD) drives, and digital versatile disc (DVD) drives, among others.

The coded instructions 1132 may be stored in the mass storage device 1130, the volatile memory 1118, the non-volatile memory 1120, the local memory 1114, and/or on a removable storage medium, such as a CD or DVD 1134.

One or more aspects of the methods and or apparatus described herein may be embedded in a structure such as a processor and/or an ASIC (application specific integrated circuit), whether instead of or in addition to at least a portion of the processing system 1100 shown in FIG. 8.

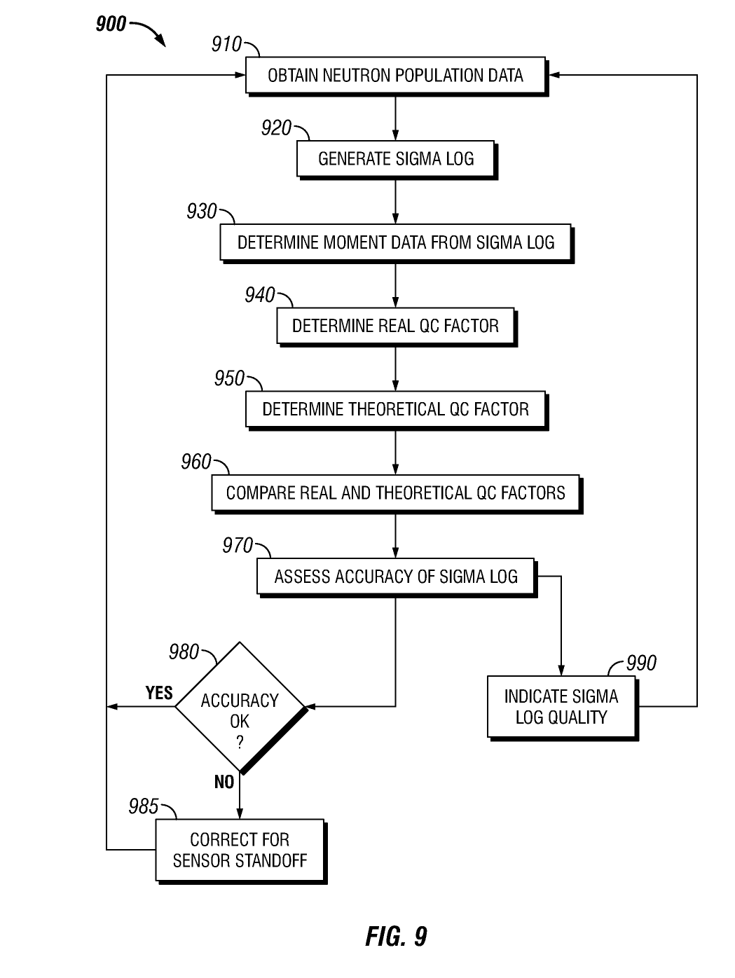

FIG. 9 is a flow-chart diagram of at least a portion of a method (900) according to one or more aspects of the present disclosure. The method (900) may be performed by apparatus shown in one or more of FIGS. 6-8. For example, the method (900) may include operating a downhole tool to obtain (910) neutron population data of a subterranean formation while the downhole tool is positioned proximate the subterranean formation in a wellbore extending from a wellsite surface to the formation. The downhole tool utilized to obtain (910) the neutron population data may have one or more aspects in common with one or more of the downhole tool 205 shown in FIG. 6, the downhole tool 220 shown in FIG. 6, the downhole tool 120 shown in FIG. 7, the downhole tool 130 shown in FIG. 7, the downhole tool 150 shown in FIG. 7, and/or one or more components of the system 1100 shown in FIG. 8. The downhole tool may be in electronic communication with, or otherwise be associated with, surface equipment located at the wellsite surface. The surface equipment may have one or more aspects in common with the logging and control system 160 shown in FIG. 6 and/or FIG. 7, and/or one or more components of the system 110 shown in FIG. 8.

The method (900) includes operating at least one of the downhole tool and the surface equipment to generate (920) a sigma log, determine (930) moment data from the sigma log, determine (940) a real quality control factor based on the moment data, determine (950) a theoretical quality control factor based on the sigma log, and compare (960) the real and theoretical quality control factors, as described above. The method (900) may further include operating at least one of the downhole tool and the surface equipment to assess (970) accuracy of the sigma log based on the comparison (960) of the real and theoretical quality control factors.

Operating at least one of the downhole tool and the surface equipment to generate (920) the sigma log may comprise determining a rate of decay of the obtained (910) neutron population data. Such determination may include determining decay constant data based on stored data regarding (A) neutron emission by the downhole tool with respect to time and (B) neutron or gamma ray detection by the downhole tool with respect to time. Determining the decay constant data based on the stored data may utilize Equation (1) set forth above. Operating at least one of the downhole tool and the surface equipment to generate (920) the sigma log may utilize Equation (2) set forth above. Operating at least one of the downhole tool and the surface equipment to determine (930) the moment data from the sigma log may include operating at least one of the downhole tool and the surface equipment to determine a first moment of the exponential function utilizing Equation (16), determine a second moment of the exponential function utilizing Equation (17), and determine a third moment of the exponential function utilizing Equation (18). Operating at least one of the downhole tool and the surface equipment to determine (940) the real quality control factor may utilize Equation (15).

Operating at least one of the downhole tool and the surface equipment to determine (950) the theoretical quality control factor comprises linearly fitting selected data points from the generated sigma log and the determined real quality control factor to determine the theoretical quality control factor. As described above and shown in FIG. 4, there may be a generally linear dependence of the determined real quality control factor from sigma, such that the theoretical quality control factor (QCth) may be obtained by, for example, fitting the dependence.

The method (900) may also include operating at least one of the downhole tool and the surface equipment to determine (980) if the accuracy of the sigma log is sufficient. If the accuracy is determined (980) to be sufficient, the method (900) may be restarted or continued by obtaining (910) additional neutron population data. If the accuracy is determined (980) to be insufficient, the sigma log may be corrected (985) for a sensor standoff associated with operation of the downhole tool, perhaps based on the assessment (970) of the sigma log accuracy. For example, at least one of the downhole tool and the surface equipment may be operated to correct (985) for the sensor standoff if the assessment (970) leads to the determination (980) that the real quality control factor is less than the theoretical quality control factor.

The method (900) may further include operating at least one of the downhole tool and the surface equipment to indicate (990) the quality of the sigma log, as a function of time, perhaps based on the comparison (960) of the real and theoretical quality control factors. For example, such indication (990) may include color-coding portions of the sigma log based on the comparison (960) of the real and theoretical quality control factors. In at least one such implementation, a first color may be used to flag portions of the sigma log that are determined (980) to be valid based on the comparison (960) of the real and theoretical quality control factors and/or the assessed (970) accuracy of the sigma log. Similarly, a second color may be used to flag portions of the sigma log that are valid but require further analysis based on the comparison (960) of the real and theoretical quality control factors and/or the assessed (970) accuracy of the sigma log. A third color may be used to flag portions of the sigma log that are invalid based on the comparison (960) of the real and theoretical quality control factors and/or the assessed (970) accuracy of the sigma log. The first color may be green, the second color may be yellow, and the third color may be red, although others may also or instead be used.

In view of the entirety of the present disclosure, including the figures, a person having skill in the art should readily recognize that the present disclosure introduces a method comprising: operating a downhole tool to obtain neutron population data of a subterranean formation, wherein the downhole tool is positioned proximate the subterranean formation in a wellbore extending from a wellsite surface to the formation, and wherein surface equipment is located at the wellsite surface; and operating at least one of the downhole tool and the surface equipment to: generate a sigma log; determine moment data from the generated sigma log; determine a real quality control factor based on the determined moment data; determine a theoretical quality control factor based on the generated sigma log; and assess accuracy of the generated sigma log by comparing the determined real and theoretical quality control factors. The downhole tool may be in electronic communication with the surface equipment.

Operating at least one of the downhole tool and the surface equipment to generate the sigma log may comprise determining a rate of decay of the obtained neutron population data. Determining the rate of decay of the obtained neutron population data may comprise determining decay constant data based on stored data regarding: neutron emission by the downhole tool with respect to time; and neutron or gamma ray detection by the downhole tool with respect to time. Determining decay constant data based on the stored data may utilize Equation (1) set forth above. Operating at least one of the downhole tool and the surface equipment to generate the sigma log may utilize Equation (2) set forth above. Operating at least one of the downhole tool and the surface equipment to determine the moment data from the generated sigma log may comprise operating at least one of the downhole tool and the surface equipment to determine a first moment of the exponential function utilizing Equation (16) set forth above, determine a second moment of the exponential function utilizing Equation (17) set forth above, and determine a third moment of the exponential function utilizing Equation (18) set forth above. Operating at least one of the downhole tool and the surface equipment to determine the real quality control factor may utilize Equation (15) set forth above.

Operating at least one of the downhole tool and the surface equipment to determine the theoretical quality control factor may comprise linearly fitting selected data points from the generated sigma log and the determined real quality control factor to determine the theoretical quality control factor.

The method may further comprise operating at least one of the downhole tool and the surface equipment to correct for a sensor standoff associated with operation of the downhole tool, based on the comparison of the determined real and theoretical quality control factors.

The method may further comprise operating at least one of the downhole tool and the surface equipment to correct for a sensor standoff associated with operation of the downhole tool if the determined real quality control factor is less than the determined theoretical quality control factor.

The method may further comprise operating at least one of the downhole tool and the surface equipment to indicate quality of the generated sigma log, as a function of time, based on the comparison of the determined real and theoretical quality control factors. Operating at least one of the downhole tool and the surface equipment to indicate quality of the generated sigma log may comprise operating at least one of the downhole tool and the surface equipment to color-code portions of the generated sigma log based on the comparison of the determined real and theoretical quality control factors. Operating at least one of the downhole tool and the surface equipment to color-code portions of the generated sigma log may comprise: using a first color to flag portions of the generated sigma log that are valid based on the comparison of the determined real and theoretical quality control factors; using a second color to flag portions of the generated sigma log that are valid but require further analysis based on the comparison of the determined real and theoretical quality control factors; and using a third color to flag portions of the generated sigma log that are invalid based on the comparison of the determined real and theoretical quality control factors. The first color may be green, the second color may be yellow, and the third color may be red.

The present disclosure also introduces a method comprising: operating a downhole tool to obtain neutron population data of a subterranean formation, wherein the downhole tool is positioned proximate the subterranean formation in a wellbore extending from a wellsite surface to the formation, and wherein surface equipment is located at the wellsite surface; and operating at least one of the downhole tool and the surface equipment to: generate a sigma log; determine moment data from the generated sigma log; determine a real quality control factor based on the determined moment data; determine a theoretical quality control factor based on the generated sigma log; assess accuracy of the generated sigma log by comparing the determined real and theoretical quality control factors; and correct for a sensor standoff associated with operation of the downhole tool, based on the comparison of the determined real and theoretical quality control factors. Operating at least one of the downhole tool and the surface equipment to correct for the sensor standoff may comprise operating at least one of the downhole tool and the surface equipment to correct for the sensor standoff if the determined real quality control factor is less than the determined theoretical quality control factor.

The present disclosure also introduces an apparatus comprising: a downhole tool operable to obtain neutron population data of a subterranean formation when the downhole tool is positioned proximate the subterranean formation in a wellbore extending from a wellsite surface to the formation, wherein: the downhole tool is associated with surface equipment located at the wellsite surface; and the downhole tool and the surface equipment are collectively operable to: generate a sigma log; determine moment data from the generated sigma log; determine a real quality control factor based on the determined moment data; determine a theoretical quality control factor based on the generated sigma log; and assess accuracy of the generated sigma log by comparing the determined real and theoretical quality control factors.

The downhole tool may be a pulsed neutron tool operable to emit neutrons into the formation and obtain the neutron population data. The pulsed neutron tool may be operable to obtain the neutron population data by detecting a count of gamma rays emitted from the formation in response to the pulsed neutron tool emission of neutrons into the formation. The pulsed neutron tool may be operable to obtain the neutron population data substantially simultaneously with the emission of neutrons into the formation and for a period of time after cessation of the emission of neutrons into the formation.

The downhole tool may be in electronic communication with the surface equipment.

The downhole tool and the surface equipment may collectively be further operable to correct for a sensor standoff associated with operation of the downhole tool based on the comparison of the determined real and theoretical quality control factors.

The downhole tool and the surface equipment may collectively be further operable to indicate quality of the generated sigma log, as a function of time, based on the comparison of the determined real and theoretical quality control factors.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same aspects introduced herein. Those skilled in the art should also realize that such equivalent constructions do not depart from the spirit and scope of the present disclosure, and that they may make various changes, substitutions and alterations herein without departing from the spirit and scope of the present disclosure. For example, although the preceding description has been described herein with reference to particular means, materials and embodiments, it is not intended to be limited to the particulars disclosed herein; rather, it extends to functionally equivalent structures, methods, and uses, such as are within the scope of the appended claims.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A method, comprising:
operating a downhole tool to obtain neutron population data of a subterranean formation, wherein the downhole tool is positioned proximate the subterranean formation in a wellbore extending from a wellsite surface to the formation, and wherein surface equipment is located at the wellsite surface; and
operating at least one of the downhole tool and the surface equipment to:
generate a sigma log;
determine moment data from the generated sigma log;
determine a real quality control factor based on the determined moment data;
determine a theoretical quality control factor based on the generated sigma log; and
assess accuracy of the generated sigma log by comparing the determined real and theoretical quality control factors.

2. The method of claim 1 wherein the downhole tool is in electronic communication with the surface equipment.

3. The method of claim 1 wherein operating at least one of the downhole tool and the surface equipment to generate the sigma log comprises determining a rate of decay of the obtained neutron population data.

4. The method of claim 3 wherein determining the rate of decay of the obtained neutron population data comprises determining decay constant data based on stored data regarding:
neutron emission by the downhole tool with respect to time; and
neutron or gamma ray detection by the downhole tool with respect to time.

5. The method of claim 4 wherein:
determining decay constant data based on the stored data utilizes an exponential function N(t)=N₀e^{-t/τ}, where N(t) is detected neutron or gamma ray count rate at time t, N₀ is an inferred initial neutron or gamma ray count rate at t=0, and τ is a decay constant;
operating at least one of the downhole tool and the surface equipment to generate the sigma log utilizes a first expression given by Σ=4550/τ, where Σ is sigma;
operating at least one of the downhole tool and the surface equipment to determine the moment data from the generated sigma log comprises operating at least one of the downhole tool and the surface equipment to:
determine a first moment of the exponential function utilizing a second expression given by M₀=(−4550×N (t))/(Σ×N₀), where M₀ is the first moment, N(t) is detected gamma ray count rate at time t, and N₀ is neutron or gamma ray count rate at time t=0;
determine a second moment of the exponential function utilizing a third expression given by M₁=(4550×M₀)/Σ, where M₁ is the second moment; and
determine a third moment of the exponential function utilizing a fourth expression given by M₂=2×(4550×M₁)/Σ where M₂ is the third moment; and
operating at least one of the downhole tool and the surface equipment to determine the real quality control factor utilizes a fifth expression given by QCᵣ=M₀×M₂/M₁².

6. The method of claim 1 wherein operating at least one of the downhole tool and the surface equipment to determine the theoretical quality control factor comprises linearly fitting selected data points from the generated sigma log and the determined real quality control factor to determine the theoretical quality control factor.

7. The method of claim 1 further comprising operating at least one of the downhole tool and the surface equipment to correct for a sensor standoff associated with operation of the downhole tool, based on the comparison of the determined real and theoretical quality control factors.

8. The method of claim 1 further comprising operating at least one of the downhole tool and the surface equipment to correct for a sensor standoff associated with operation of the downhole tool if the determined real quality control factor is less than the determined theoretical quality control factor.

9. The method of claim 1 further comprising operating at least one of the downhole tool and the surface equipment to indicate quality of the generated sigma log, as a function of time, based on the comparison of the determined real and theoretical quality control factors.

10. The method of claim 9 wherein operating at least one of the downhole tool and the surface equipment to indicate quality of the generated sigma log comprises operating at least one of the downhole tool and the surface equipment to color-code portions of the generated sigma log based on the comparison of the determined real and theoretical quality control factors.

11. The method of claim 10 wherein operating at least one of the downhole tool and the surface equipment to color-code portions of the generated sigma log comprises:
using a first color to flag portions of the generated sigma log that are valid based on the comparison of the determined real and theoretical quality control factors;
using a second color to flag portions of the generated sigma log that are valid but require further analysis based on the comparison of the determined real and theoretical quality control factors; and
using a third color to flag portions of the generated sigma log that are invalid based on the comparison of the determined real and theoretical quality control factors.

12. A method, comprising:
operating a downhole tool to obtain neutron population data of a subterranean formation, wherein the downhole tool is positioned proximate the subterranean formation in a wellbore extending from a wellsite surface to the formation, and wherein surface equipment is located at the wellsite surface; and
operating at least one of the downhole tool and the surface equipment to:
generate a sigma log;
determine moment data from the generated sigma log;
determine a real quality control factor based on the determined moment data;
determine a theoretical quality control factor based on the generated sigma log;
assess accuracy of the generated sigma log by comparing the determined real and theoretical quality control factors; and
correct for a sensor standoff associated with operation of the downhole tool, based on the comparison of the determined real and theoretical quality control factors.

13. The method of claim 12 wherein operating at least one of the downhole tool and the surface equipment to correct for the sensor standoff comprises operating at least one of the downhole tool and the surface equipment to correct for the sensor standoff if the determined real quality control factor is less than the determined theoretical quality control factor.

14. An apparatus, comprising:
a downhole tool operable to obtain neutron population data of a subterranean formation when the downhole tool is positioned proximate the subterranean formation in a wellbore extending from a wellsite surface to the formation, wherein:
the downhole tool is associated with surface equipment located at the wellsite surface; and
the downhole tool and the surface equipment are collectively operable to:
generate a sigma log;
determine moment data from the generated sigma log;
determine a real quality control factor based on the determined moment data;
determine a theoretical quality control factor based on the generated sigma log; and
assess accuracy of the generated sigma log by comparing the determined real and theoretical quality control factors.

15. The apparatus of claim 14 wherein the downhole tool is a pulsed neutron tool operable to emit neutrons into the formation and obtain the neutron population data.

16. The apparatus of claim 15 wherein the pulsed neutron tool is operable to obtain the neutron population data by detecting a count of gamma rays emitted from the formation in response to the pulsed neutron tool emission of neutrons into the formation.

17. The apparatus of claim 16 wherein the pulsed neutron tool is operable to obtain the neutron population data substantially simultaneously with the emission of neutrons into the formation and for a period of time after cessation of the emission of neutrons into the formation.

18. The apparatus of claim 14 wherein the downhole tool is in electronic communication with the surface equipment.

19. The apparatus of claim 14 wherein the downhole tool and the surface equipment are collectively further operable to correct for a sensor standoff associated with operation of the downhole tool based on the comparison of the determined real and theoretical quality control factors.

20. The apparatus of claim 14 wherein the downhole tool and the surface equipment are collectively further operable to indicate quality of the generated sigma log, as a function of time, based on the comparison of the determined real and theoretical quality control factors.
